(19) United States
(12) Patent Application Publication
(10) Pub. No.: US 2013/0177344 A1
(43) Pub. Date: Jul. 11, 2013

(54) PRINTER CAPABLE OF SELECTIVELY PRINTING IN CONTINUOUS PAPER SHEET MODE OR SINGLE PAPER SHEET MODE

(71) Applicant: K. C. YANG, New Taipei City (TW)

(72) Inventor: K. C. YANG, New Taipei City (TW)

(21) Appl. No.: 13/345,675

(22) Filed: Jan. 7, 2012

(51) Int. Cl. B41J 11/66

(52) U.S. Cl. 400/621

(57) ABSTRACT

A printer is provided with an upstream supply unit filled with stacked continuous paper sheets; a feeding unit after the supply unit; a guide member upstream of the feeding unit; a first sensor between the guide member and the feeding unit; a second sensor downstream of the feeding unit; a printing head; a cutting device; and a stacking unit downstream of the cutting device. In a single paper sheet printing mode the cutting device is activated to cut the leading edge of the passing continuous paper sheet by moving from one side of the frame to the other side thereof to form a single paper sheet and cut the leading edge of the passing continuous paper sheet by moving from the other side of the frame to one side thereof to form another single paper sheet after advancement of the continuous paper sheet.

### BACKGROUND OF THE INVENTION

1. Field of the Invention

The invention relates to printers and more particularly to a printer capable of selectively printing in continuous paper sheet mode or single paper sheet mode.

2. Description of Related Art

Until now inexpensive printers such as dot-matrix and line printers are only printers dedicated to continuous forms (i.e., continuous paper sheets). For an operator operating the dot-matrix printer, the operator is required to manually cut and remove the continuous form. This is a laborious and time consuming job.

To the contrary, some types of printers, for example laser printers, are dedicated to cutforms (i.e., single paper sheets). For a user wanting to print on both types of forms, the user has to purchase the two dedicated printers which unfortunately can impose a great financial burden on the user.

The invention discussed below aims to provide a single printer capable of selectively printing in either continuous paper sheet mode or single paper sheet mode for fulfilling above needs.

### SUMMARY OF THE INVENTION

It is therefore one object of the invention to provide an apparatus for feeding a unitized continuous paper sheet which is able to be fed into and removed from a printer, comprising an upstream supply unit comprising a cassette filled with stacked continuous paper sheets; a feeding unit disposed after the supply unit and comprising a motor-driven tractor for tracking the continuous paper sheets forward; a guide member disposed upstream of the feeding unit; a first sensor disposed downstream of the guide member and upstream of the feeding unit, the first sensor being for sensing at least one of jam and skew of the continuous paper sheet; a second sensor disposed downstream of the feeding unit, the second sensor being for sensing arrival of a leading edge of the continuous paper sheet; a printing head disposed downstream of the second sensor for printing text and/or graphics on the continuous paper sheets; a cutting device disposed downstream of the printing head and comprising an elongated frame across both sides of the continuous paper sheet, two gears wherein one gear is a motor driven gear, a drive belt meshing with the gears for power transmission, and a cutter secured to the drive belt; a stacking unit disposed downstream of the cutting device and comprising an arc guide, a flat guide spaced from the arc guide, a guide path defined between and by the arc guide and the flat guide, a motor driven drive roll under the arc guide, a driven roll under the flat guide being driven by the drive roll, a stacker disposed under the drive and driven rolls; and an operator panel disposed on top of the printer, wherein in a single paper sheet printing mode as selected by operating the operator panel and in response to printing the continuous paper sheets by the printing head, the cutting device is activated to cut the leading edge of the passing continuous paper sheet by moving from one side of the frame to the other side thereof to form a single paper sheet and cut the leading edge of the passing continuous paper sheet by moving from the other side of the frame to one side thereof to form another single paper sheet after a predetermined advancement of the continuous paper sheet, and the cut single paper sheet falls into the stacker after passing the guide path and a joining line of the drive roll and the driven roll; and wherein in a continuous paper sheet printing mode as selected by operating the operator panel and in response to printing the continuous paper sheets by the printing head, the cutting device is deactivated so that the continuous paper sheet remains uncut prior to passing the guide path, the joining line of the drive roll and the driven roll, and falling into the stacker.

The above and other objects, features and advantages of the invention will become apparent from the following detailed description taken with the accompanying drawings.

### BRIEF DESCRIPTION OF THE DRAWINGS

FIG. 1 is a perspective view of a printer capable of selectively printing in continuous paper sheet mode or single paper sheet mode according to the invention, viewing from a position above and in front of the printer;

FIG. 2 is another perspective view of the printer but viewing from a rear position;

FIG. 3 is a side elevation of the printer;

FIG. 4 is a view similar to FIG. 3 showing a continuous paper sheet printing mode;

FIG. 5 is a perspective of FIG. 4 but viewing from a rear position above the printer;

FIG. 6 is a view similar to FIG. 5 showing the continuous paper sheets being cut by the cutter;

FIG. 7 is a perspective view of the cutting device;

FIG. 7A is a side elevation of FIG. 7;

FIGS. 8A and 8B are side elevations of a rear part of the printer showing the continuous paper sheets being stacked in the stacker after printing; and

FIG. 9 is a view similar to FIG. 8A or 8B showing the continuous paper sheets being cut into single paper sheets and stacked in the stacker after printing.

### DETAILED DESCRIPTION OF THE INVENTION

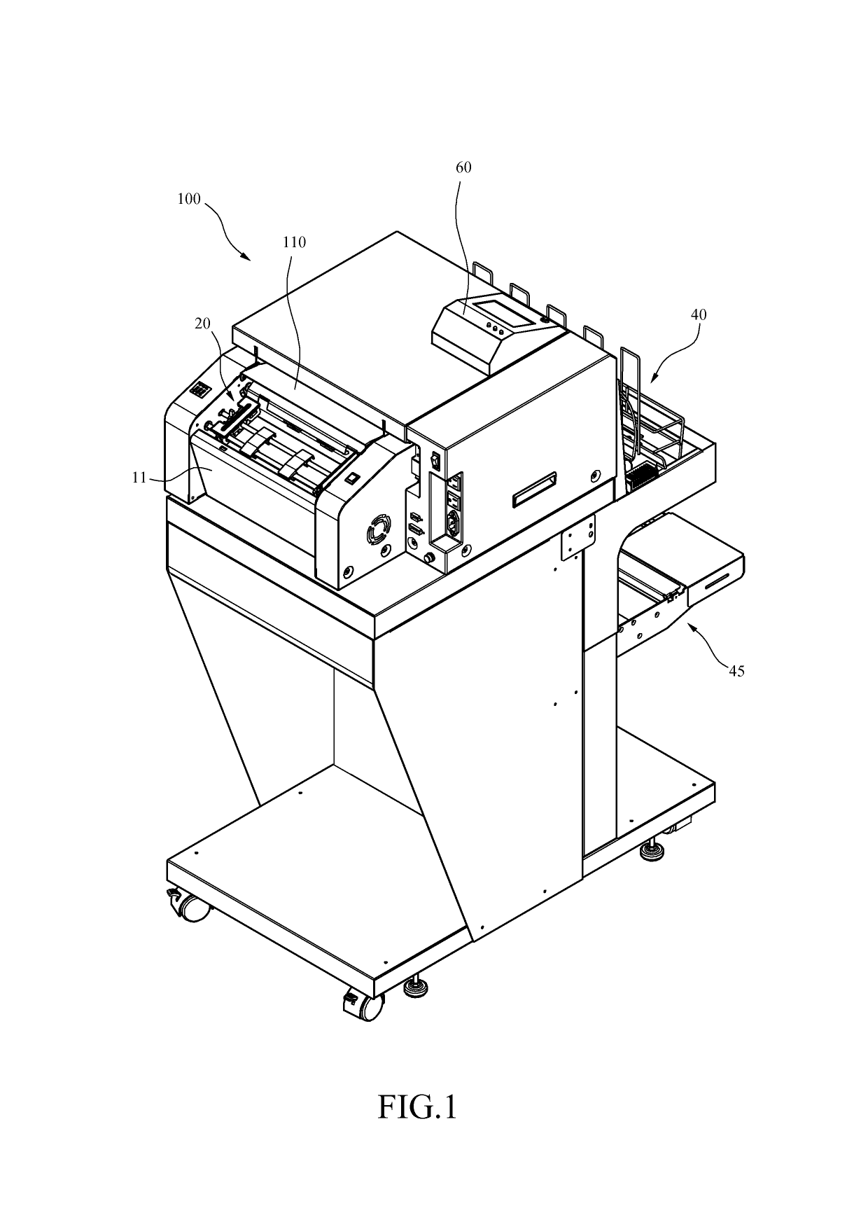

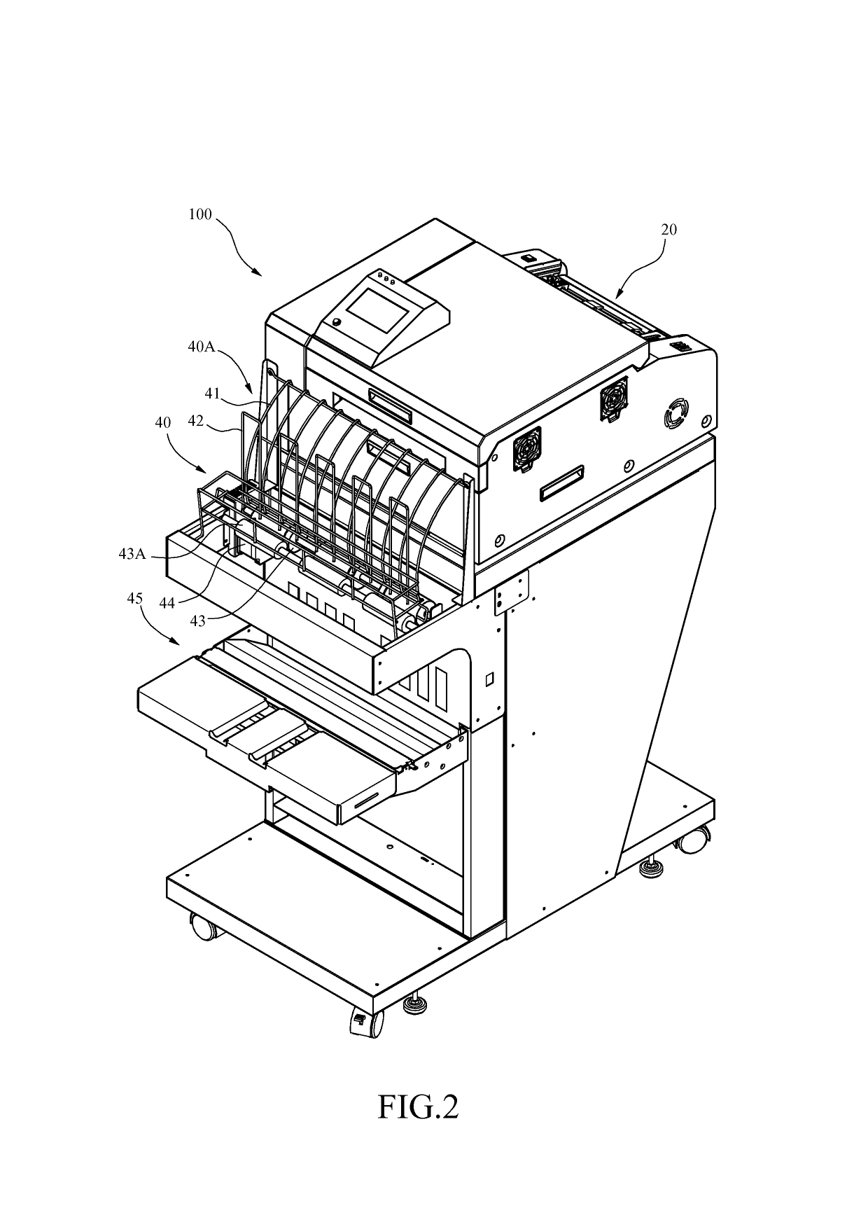

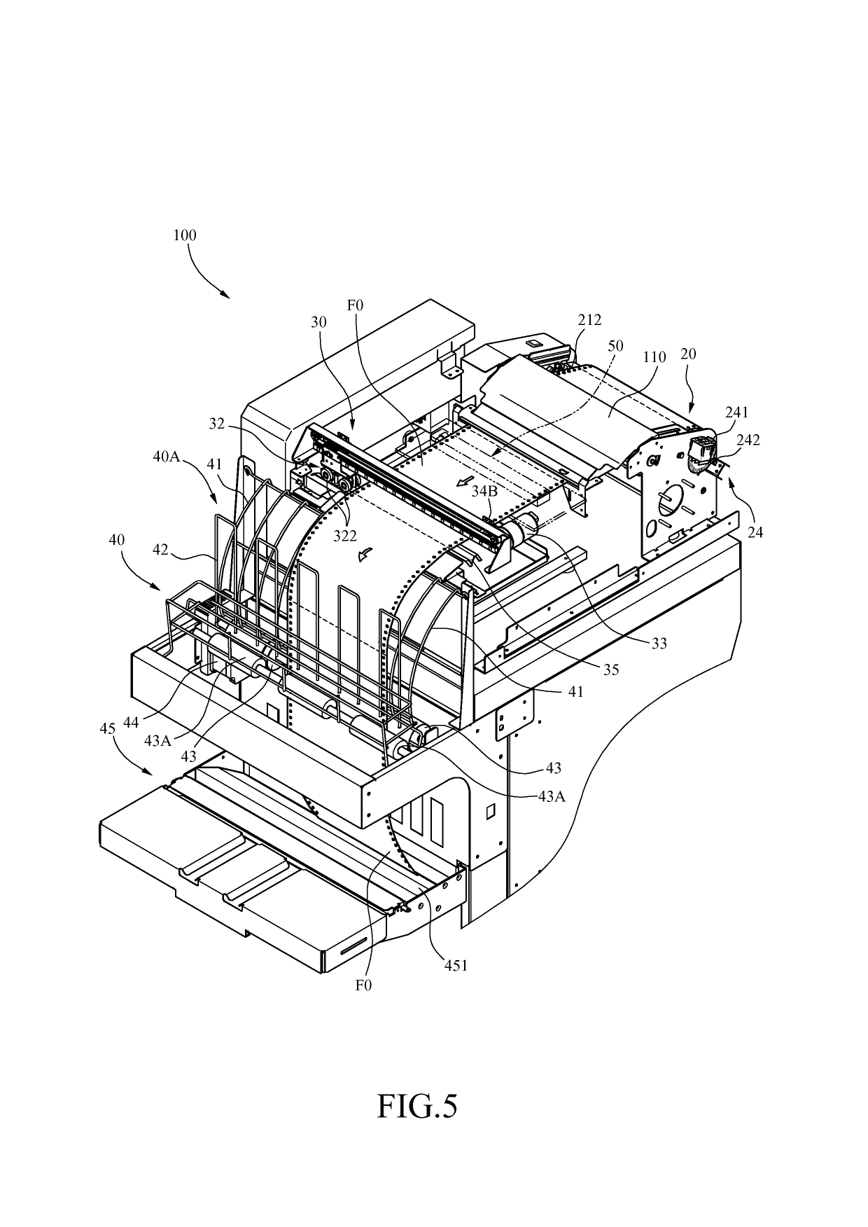

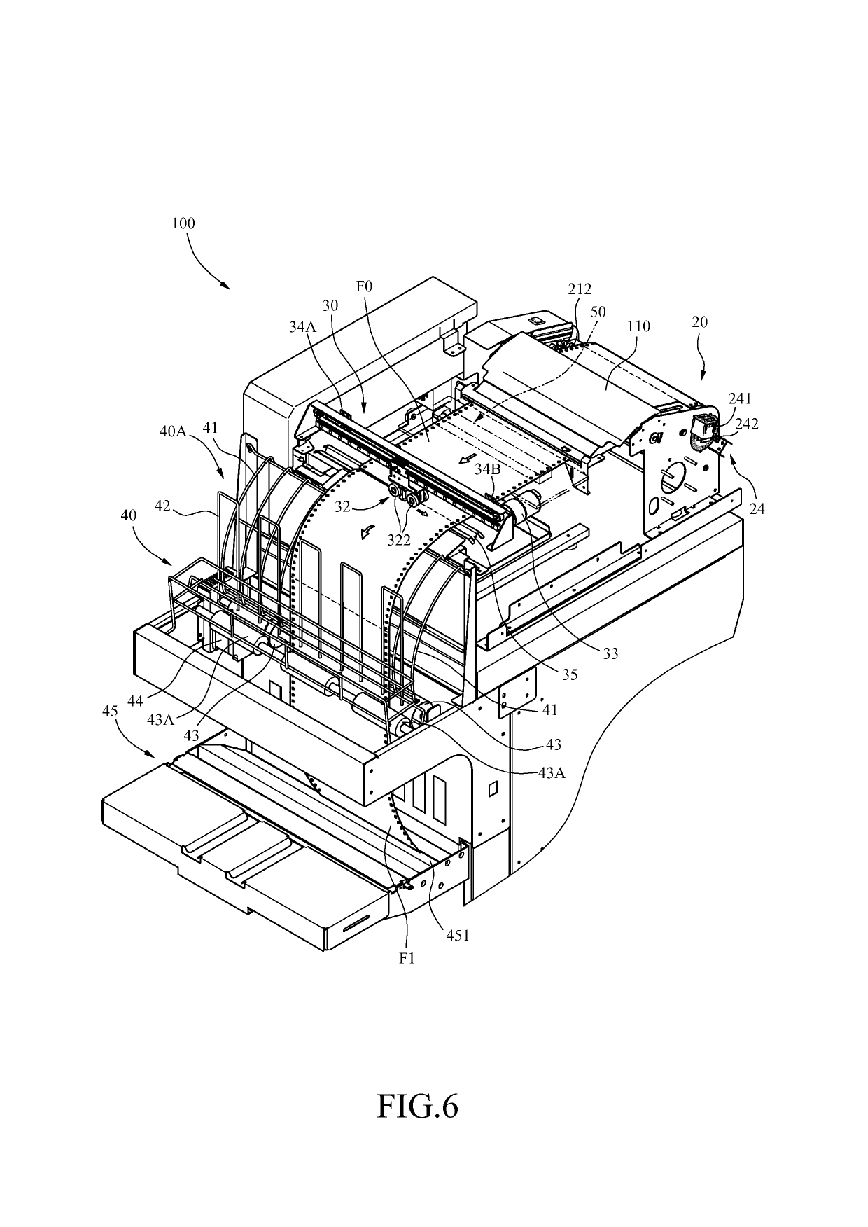

Referring to FIGS. 1 to 9, a printer 100 in accordance with the invention is shown. The invention comprises the following components.

A cassette 10A filled with continuous paper sheets FO is disposed in upstream. Continuous paper sheet F0 is perforated transversely at regular intervals with a line of small slits which form a tear edge that defines the top and bottom of each page. When unfolded into a flat continuous sheet, this slit perforation closes up to allow the printer to print across the perforated edge without stopping or jamming. The paper sheet F0 is also punched longitudinally along both side edges with, for example, 4 mm diameter engagement holes at a regular spacing. These holes engage with sprocket wheels or toothed belts which push or pull the paper through the printer 100 as well known in the art. A feeding path 110 extends from the cassette 10A to the printer 100.

The printer 100 itself comprises a supply unit 10, a feeding unit 20, a printing head (50) disposed downstream of the feeding unit 20, a cutting device 30 disposed downstream of the printing head (50), and a stacking unit 40 in which the feeding path 110 starts at the supply unit 10 and ends at the stacking unit 40 via the feeding unit 20 and the cutting device 30. The printing head (50) is adapted to print text and/or graphics on the continuous paper sheets (F0).

The feeding unit 20 comprises a tractor 21, a motor 22 and a driving shaft 23. The tractor 21 comprises a roller chain 211 meshed with projections 212 which are engaged with side holes of the paper sheet F0. A counter 24 is provided on one side of the tractor 21. A dial 241 is formed on the surface of the counter 24. A light blocking member 242 is provided on a lower portion of the counter 24 for sensing the passing paper sheets F0.

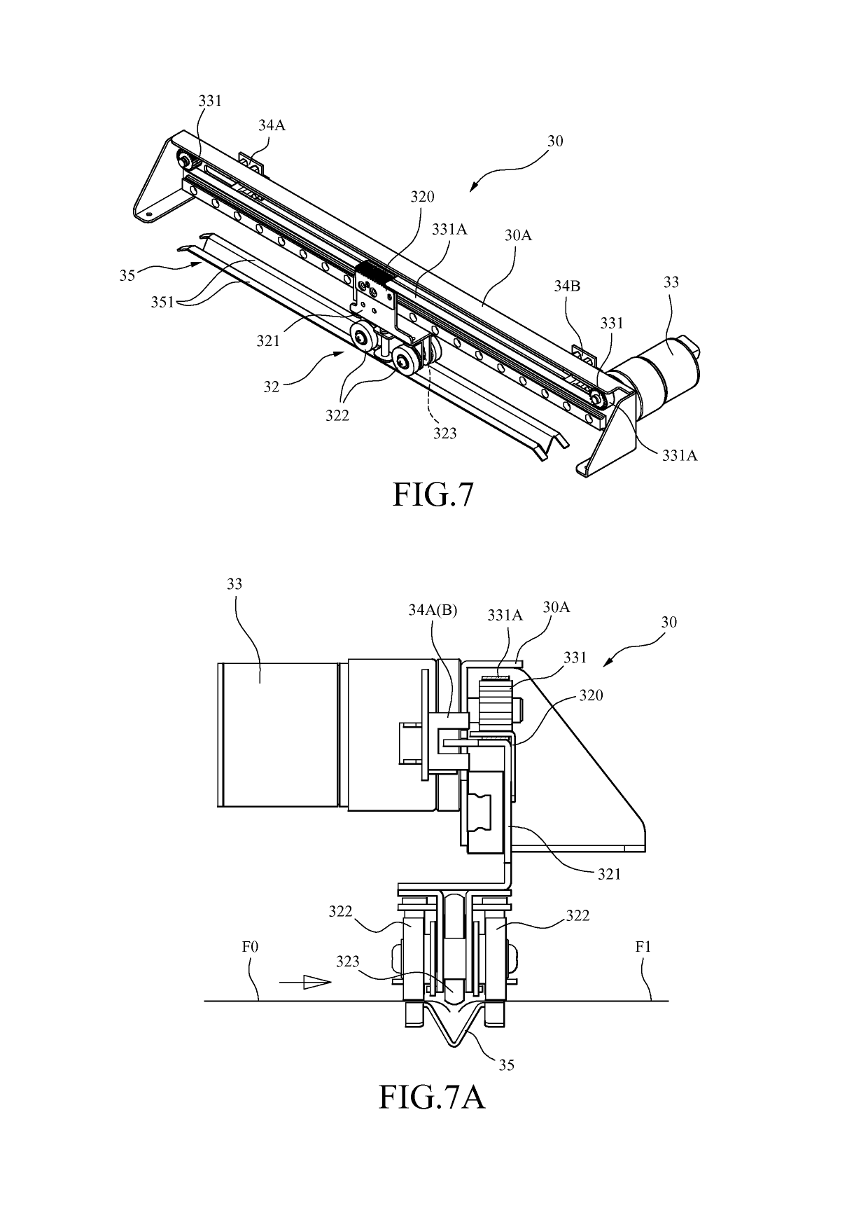

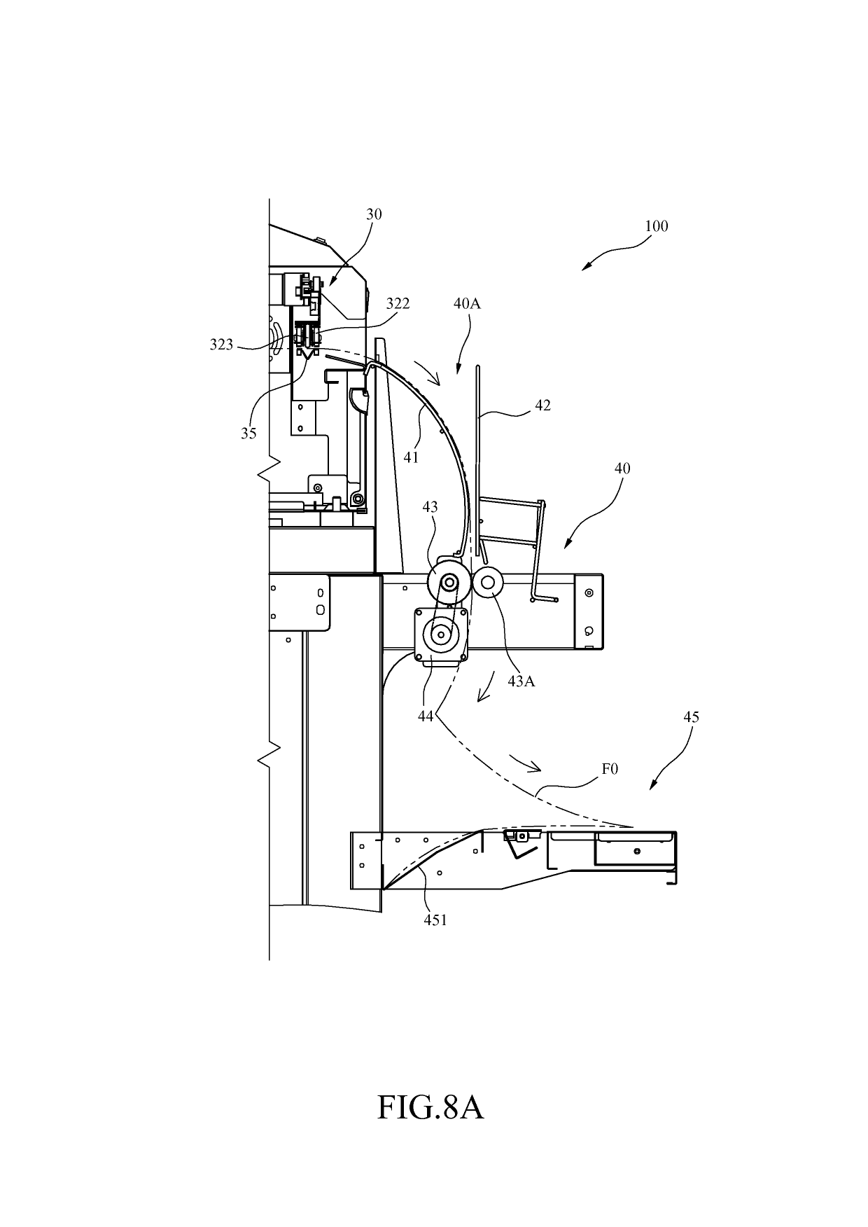

As shown in FIGS. 7 and 7A, the cutting device 30 is provided downstream of the printing head 50 and comprises an elongated frame 30A across both sides of the paper sheet F0, a motor 33 provided externally of the frame 30A, two gears 331 at both sides of the frame 30A respectively in which one gear 331 is driven by a driving shaft of the motor 33, a drive belt 331A with teethed inner surface meshed with the gears 331 for power transmission, a corresponding cutting member 35 of V longitudinal section provided under the frame 30A and including two parallel rails 351 on top, a cutter 32 including four wheels 322 rotatably disposed on the rails 351 for moving the cutter 32 to and fro along the rails 351, a cutting element 323 between two wheels 322 on one rail 351 and two wheels 322 on the other rail 351 with the four wheels 322 being rotatably mounted therewith, a coupling member 320 secured to the drive belt 331A, and a wheel mount 321 having a lower end secured to the cutting element 323 and an upper end secured to the coupling member 320, and two spaced first and second location sensors 34A, 34B each disposed proximal to the gear 331 and adapted to sense the presence of the cutter 32 adjacent thereto. In the present embodiment, the cutter 32 is located adjacent to the first location sensor 34A in an inoperative position.

A first sensor 51 is provided between a guide member 11 and the tractor 21 along the feeding path 110 and is adapted to sense the jam and/or skew of the paper sheet FO approaching the printing head 50. A second sensor 52 is provided upstream of the printing head 50 and is adapted to sense the arrival of the leading edge of the paper sheet F0. Further, the second sensor 52 may issue a signal to the counter 24 to count the number of the continuously passing paper sheets F0.

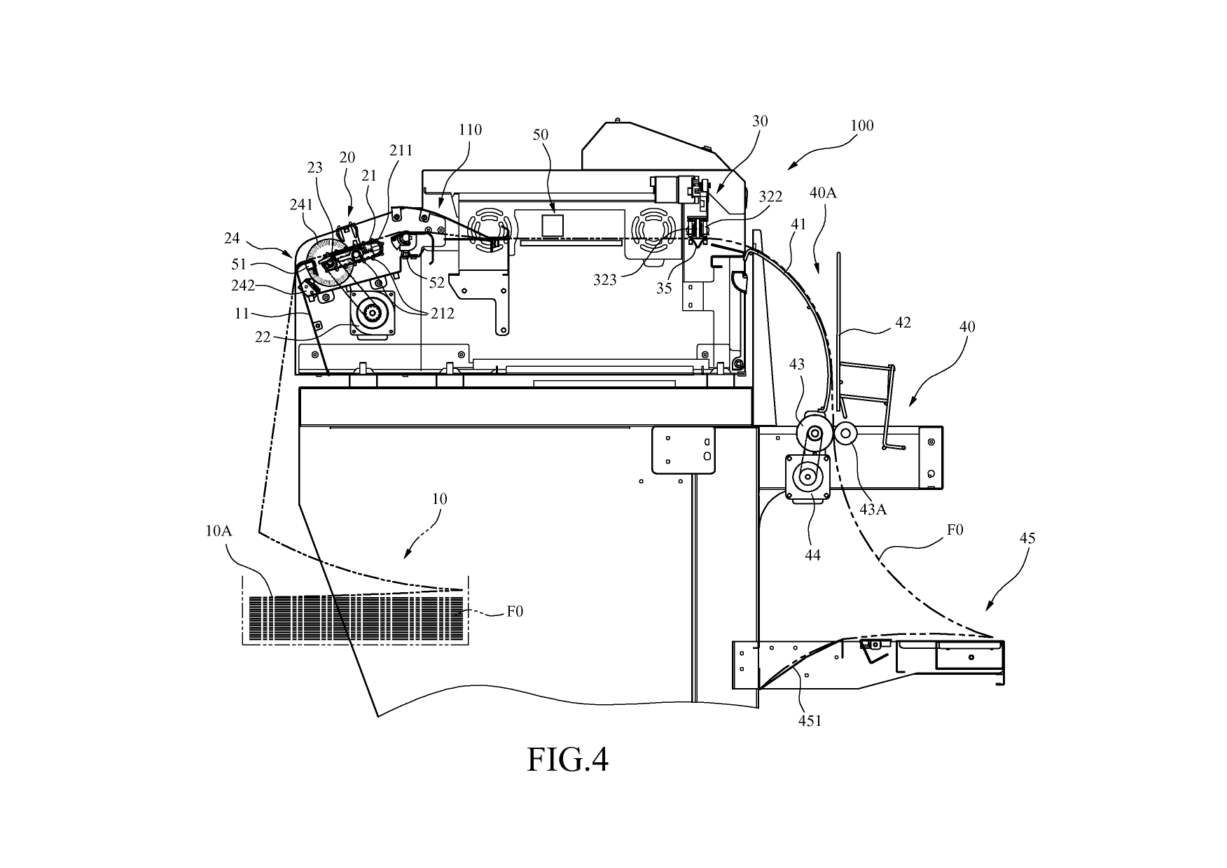

As shown in FIGS. 4, 5, 6, 7 and 7A, the motor 33 is activated in response to the paper sheet F0 entering a predetermined cutting zone and sensed by the second sensor 52. And in turn, the cutting element 323 is lowered to cut the tear edge of paper sheet F0 by moving from one side of the paper sheet F0 to the other side thereof by cooperating with the corresponding cutting member 35 (see FIG. 7A). The second location sensor 34B can sense the arrival of the cutting element 323. And in response the second location sensor 34B issues an instruction to the motor 33 to stop the cutting element 323 and lift same until being positioned and stopped. That is, the cutting element 323 stays at a position adjacent to the second location sensor 34B (i.e., the other side of the frame 30A) after the cutting. And in turn, the motor 33 is halted. In brief, the cutter 32 cuts the paper sheet F0 in a movement from one side of the frame 30A to the other side thereof.

The second location sensor 34B may sense the paper sheet FO entering a predetermined cutting zone. And in response, the second location sensor 34B issues an instruction to activate the motor 33 which lowers the cutting element 323 to a ready to cut position. And in turn, the cutting element 323 cuts the tear edge of paper sheet FO by moving from the other side of the paper sheet F0 to one side thereof by cooperating with the corresponding cutting member 35. The first location sensor 34A can sense the arrival of the cutting element 323. And in response the first location sensor 34A issues an instruction to the motor 33 to stop the cutting element 323 and lift same until being positioned and stopped. That is, the cutting element 323 stays at a position adjacent to the first location sensor 34A (i.e., one side of the frame 30A) after the cutting. And in turn, the motor 33 is halted. In brief, the cutter 32 cuts the paper sheet FO in a movement from the other side of the frame 30A to one side thereof.

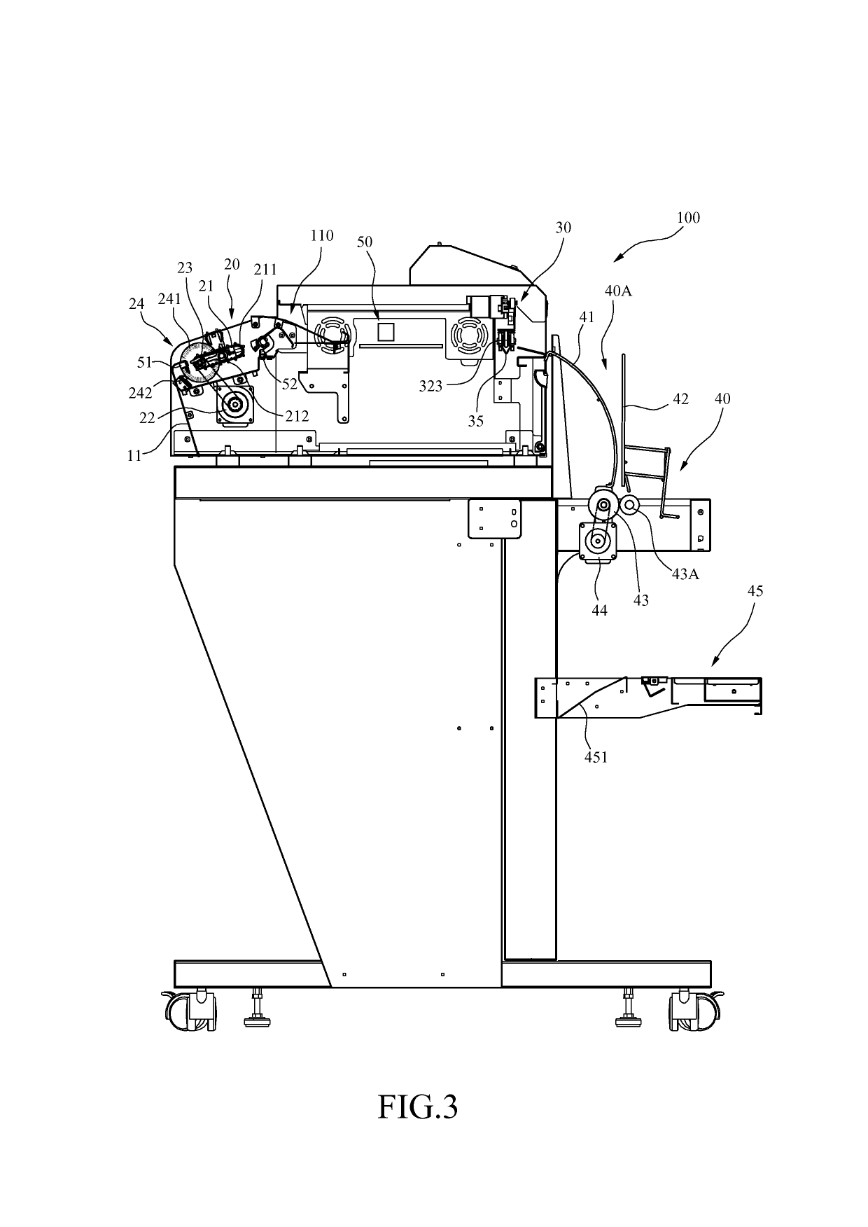

As shown in FIGS. 3, 4, 5, 6, 8A, 8B and 9, the stacking unit 40 is located downstream of the cutting device 30 and comprises an arc guide 41, a flat guide 42 spaced from the arc guide 41 and disposed about vertical, a guide path 40A defined between and by the arc guide 41 and the flat guide 42, a drive roll 43 and a driven roll 43A under the guides 41, 42 respectively, a motor 44 for rotating the drive roll 43, a stacker 45 provided under the motor 44 and including an inclined board 451 about directly under the motor 44. The printed single paper sheets F1 are stacked in the stacker 45 in order with the help of the inclined board 451.

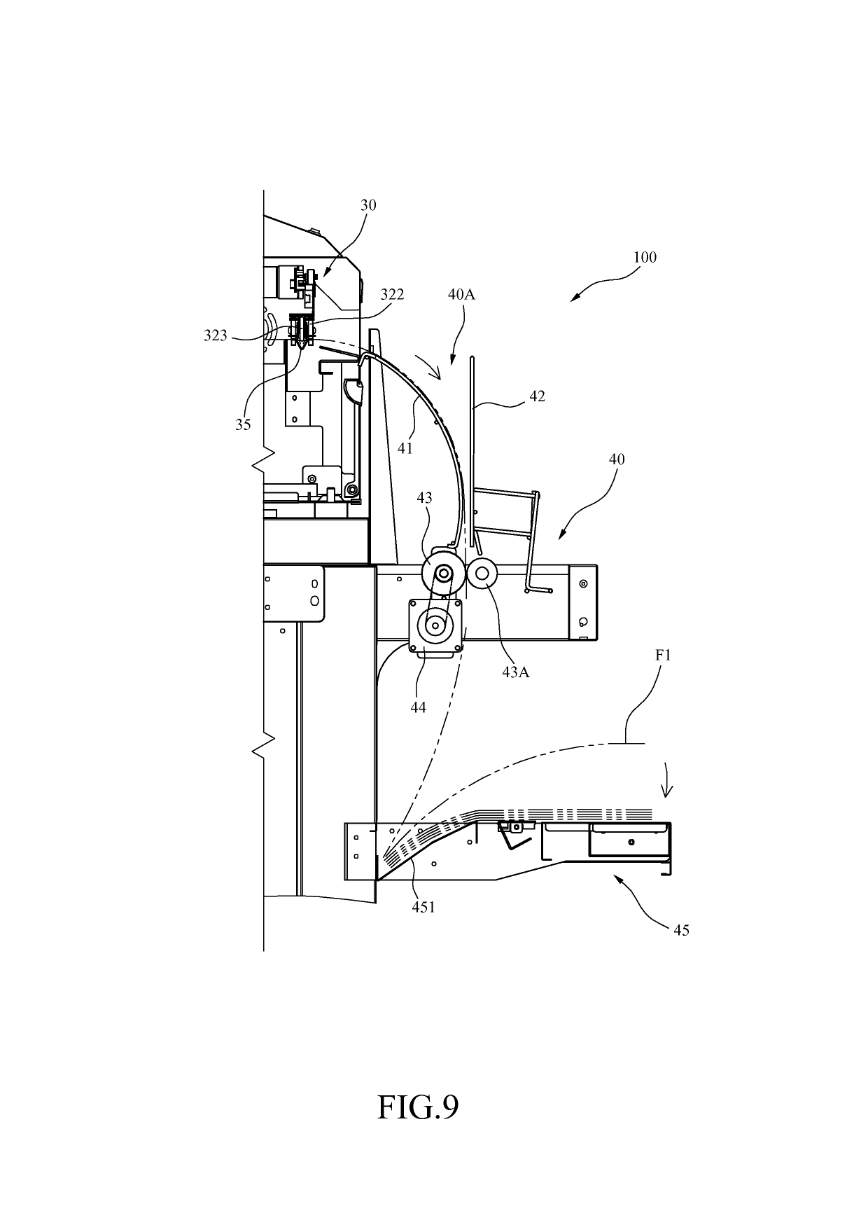

In a single paper sheet printing mode as selected by operating an operator panel 60 on top of the printer 100 by a printer operator, the paper sheets F0 in the cassette 10A are fed to the feeding unit 20 and in turn are fed to the printing head 50 along the feeding path 110 to be printed. After printing, the dial 241 and the light blocking member 242 are activated to send a cutting signal to the cutting device 30. The cutting device 30 is thus activated to cause the cutting element 323 to cut the leading edge of the passing paper sheet F0 to form a single paper sheet F1 (see FIG. 7A). Next, the single paper sheet F1 falls toward the joining line of the drive roll 43 and the driven roll 43A after passing the guide path 40A. The printed single paper sheet F1 falls in the stacker 45 with the help of the inclined board 451. Finally, the printed single paper sheets F1 are stacked in the stacker 45 in order (see FIG. 9).

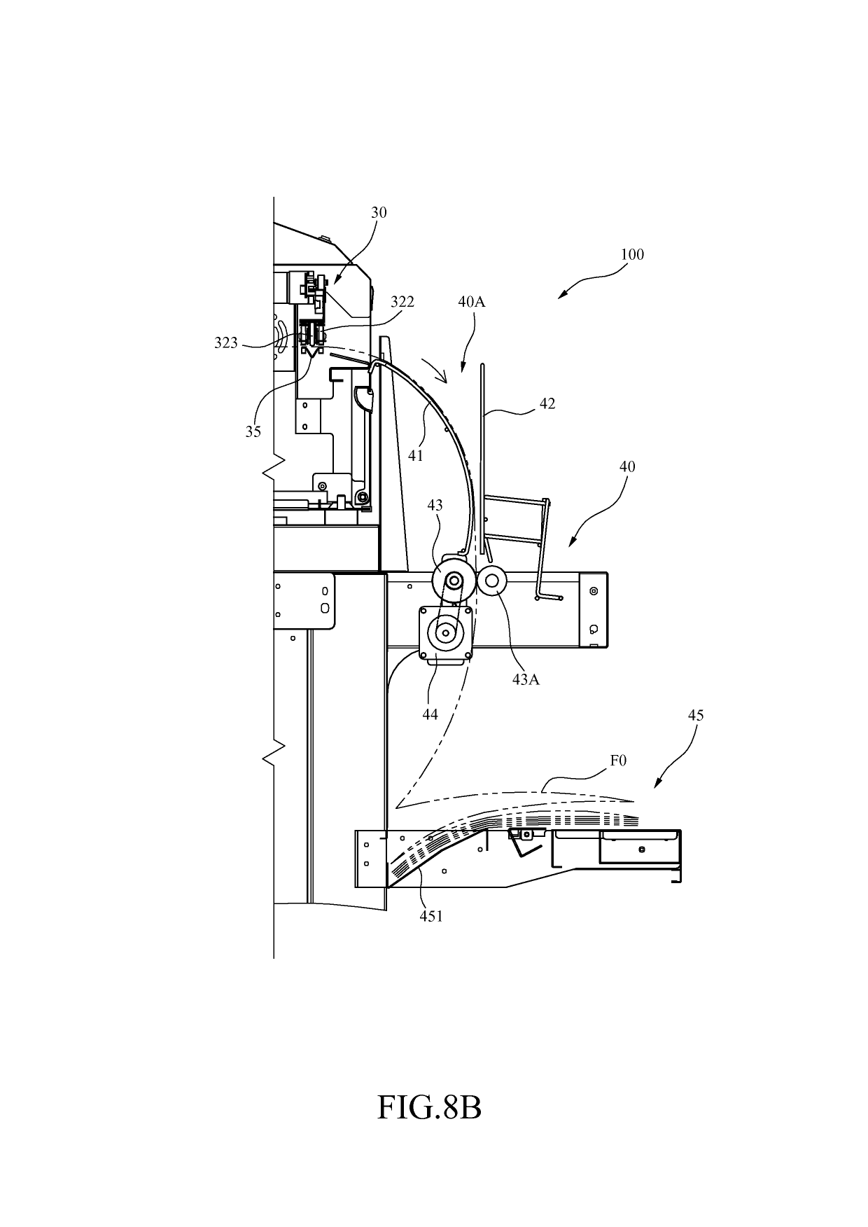

In a continuous paper sheet printing mode as selected by operating the operator panel 60 by the printer operator, the paper sheets F0 in the cassette 10A are fed to the feeding unit 20 and in turn are fed to the printing head 50 along the feeding path 110 to be printed. After printing, the dial 241 and the light blocking member 242 are activated to send a cutting disable signal to the cutting device 30. The cutting device 30 is thus deactivated. Next, the paper sheet FO fall toward the joining line of the drive roll 43 and the driven roll 43A after passing the guide path 40A. The printed paper sheet F0 falls in the stacker 45 with the help of the inclined board 451. Finally, the printed paper sheets F0 are stacked in the stacker 45 in order (see FIGS. 4, 8A and 8B).

In one embodiment, the printer 100 is an ink jet printer and is adapted to selectively print in continuous paper sheet mode or single paper sheet mode when continuous paper sheets are stacked in the cassette 10A. Alternatively, paper sheets stacked in the cassette 10A are single paper sheets so that the ink jet printer may operate in single paper sheet mode as known in the art.

While the invention has been described in terms of preferred embodiments, those skilled in the art will recognize that the invention can be practiced with modifications within the spirit and scope of the appended claims.

What is claimed is:

1. An apparatus for feeding a unitized continuous paper sheet which is able to be fed into and removed from a printer (100), comprising:
an upstream supply unit (10) comprising a cassette (10A) filled with stacked continuous paper sheets (F0), and a guide member (11) for guiding the continuous paper sheets (F0) forward;
a feeding unit (20) disposed after the supply unit (10) and comprising a motor-driven tractor (21) for tracking the continuous paper sheets (F0) forward;
a first sensor (51) disposed downstream of the guide member (11) and upstream of the feeding unit (20), the first sensor (51) being for sensing at least one of jam and skew of the continuous paper sheet (F0);
a second sensor (52) disposed downstream of the feeding unit (20), the second sensor (52) being for sensing arrival of a leading edge of the continuous paper sheet (F0);
a printing head (50) disposed downstream of the second sensor (52) for printing text and/or graphics on the continuous paper sheets (F0);
a cutting device (30) disposed downstream of the printing head (50) and comprising an elongated frame (30A) across both sides of the continuous paper sheet (F0), two gears (331) wherein one gear (331) is a motor driven gear, a drive belt (331A) meshing with the gears (331) for power transmission, and a cutter (32) secured to the drive belt (331);
a stacking unit (40) disposed downstream of the cutting device (30) and comprising an arc guide (41), a flat guide (42) spaced from the arc guide (41), a guide path (40A) defined between and by the arc guide (41) and the flat guide (42), a motor driven drive roll (43) under the arc guide (41), a driven roll (43A) under the flat guide (42) being driven by the drive roll (43), a stacker (45) disposed under the drive and driven rolls (43, 43A); and
an operator panel (60) disposed on top of the printer (100),
wherein in a single paper sheet printing mode as selected by operating the operator panel (60) and in response to printing the continuous paper sheets (F0) by the printing head (50), the cutting device (30) is activated to cut the leading edge of the passing continuous paper sheet (F0) by moving from one side of the frame (30A) to the other side thereof to form a single paper sheet (F1) and cut the leading edge of the passing continuous paper sheet (F0) by moving from the other side of the frame (30A) to one side thereof to form another single paper sheet (F1) after a predetermined advancement of the continuous paper sheet (F0), and the cut single paper sheet (F1) falls into the stacker (45) after passing the guide path (40A) and a joining line of the drive roll (43) and the driven roll (43A); and
wherein in a continuous paper sheet printing mode as selected by operating the operator panel (60) and in response to printing the continuous paper sheets (F0) by the printing head (50), the cutting device (30) is deactivated so that the continuous paper sheet (F0) remains uncut prior to passing the guide path (40A), the joining line of the drive roll (43) and the driven roll (43A), and falling into the stacker (45).

2. The apparatus of claim 1, wherein the cutting device (30) further comprises a corresponding cutting member(35) of V longitudinal section disposed under the frame (30A) and including two parallel rails 351 on a top portion; and wherein the cutter (32) comprises four wheels (322) rotatably disposed on the rails (351) for moving the cutter (32) to and fro along the rails (351), a cutting element (323) between the two wheels (322) on one rail (351) and the other two wheels (322) on the other rail (351), the cutting element (323) being rotatably mounted with the four wheels (322), a coupling member (320) secured to the drive belt (331A), and a wheel mount (321) having one end secured to the cutting element (323) and the other end secured to the coupling member (320), and two spaced first and second location sensors (34A, 34B) each disposed proximal to the gear (331), the first and second location sensors (34A, 34B) being for sensing presence of the cutter (32).

3. The apparatus of claim 1, wherein the stacker (45) comprises an inclined board (451).

4. The apparatus of claim 1, wherein the feeding unit (20) further comprises a counter (24) disposed on one side of the tractor (21), a dial (241) formed on the counter (24), and a light blocking member (242) disposed on a lower portion of the counter (24) for sensing any abnormalities of the continuous paper sheets (F0).

5. The apparatus of claim 4, wherein the second sensor (52) issues a signal to the counter (24) in response to sensing the arrival of the leading edge of the continuous paper sheet (F0) so that the counter (24) counts the number of the passing continuous paper sheets (F0).

6. The apparatus of claim 2, wherein the second location sensor (34B) stops the cutting and causes the cutter (32) to dispose in a first inoperative position adjacent to the other side of the frame (30A) after sensing arrival of the cutter (32), and the first location sensor (34A) stops the cutting and causes the cutter (32) to dispose in a second inoperative position adjacent to one side of the frame (30A) after sensing arrival of the cutter (32).
